(19) United States
(12) Patent Application Publication
(10) Pub. No.: US 2013/0003023 A1
(43) Pub. Date: Jan. 3, 2013

(54) DIGITAL LIGHTING PROCESS PROJECTION DEVICE

(75) Inventor: YUNG-LUN HUANG, Tu-Cheng (TW)

(73) Assignee: HON HAI PRECISION INDUSTRY CO., LTD., Tu-Cheng (TW)

(21) Appl. No.: 13/338,278

(22) Filed: Dec. 28, 2011

(30) Foreign Application Priority Data
Jun. 30, 2011 (TW) 100122966

(51) Int. Cl. G03B 21/14

(52) U.S. Cl. 353/31

(57) ABSTRACT

A digital lighting process (DLP) projection device is provided. The DLP projection device includes a laser, a digital micromirror device (DMD), a projection lens, and a lens array. The laser emits laser light. The DMD receives the laser light emitted from the laser. The DMD includes a plurality of micromirrors arranged in an array, each of which reflects the laser light. The projection lens receives the laser light reflected from the micromirror, and projects the received laser light. The lens array is arranged between the laser and the DMD, and makes the laser light emitted from the laser uniform.

### BACKGROUND

1. Technical Field

The present disclosure relates to projection devices and, particularly, to a digital lighting process (DLP) projection device.

2. Description of Related Art

In order to improve a brightness of a digital lighting process (DLP) projection device, a laser, instead of a light-emitting diode (LED), is often used as the light source of the DLP projection device. However, there is uneven Gaussian intensity distribution when using the laser, which results in uneven in the brightness of a projection image.

Therefore, what is needed is a digital lighting process projection device to overcome the described limitations.

### BRIEF DESCRIPTION OF THE DRAWINGS

FIG. 1 is a schematic illustration of a digital lighting process projection device, in accordance with an exemplary embodiment.

FIG. 2 is a schematic illustration of a digital micromirror device (DMD) of the digital lighting process projection device of FIG. 1.

### DETAILED DESCRIPTION

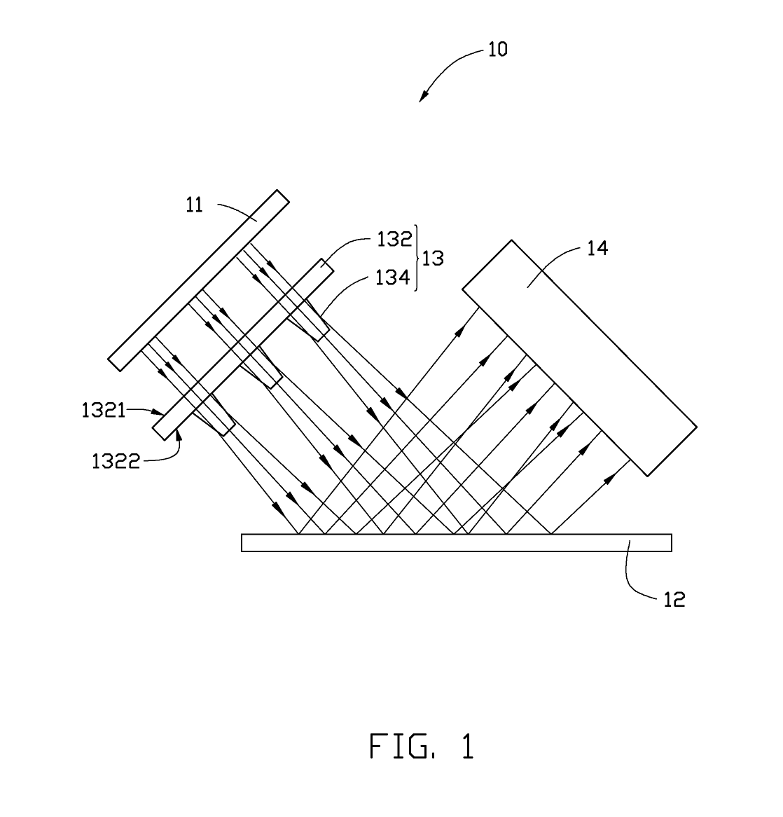

FIG. 1 is a schematic illustration of a digital lighting process (DLP) projection device. The DLP projection device 10 includes a laser 11, a digital micromirror device (DMD) 12 arranged at a predetermined angle to the laser 11, a lens array 13 arranged between the laser 11 and the DMD 12, and a projection lens 14. The laser 11 is a laser diode.

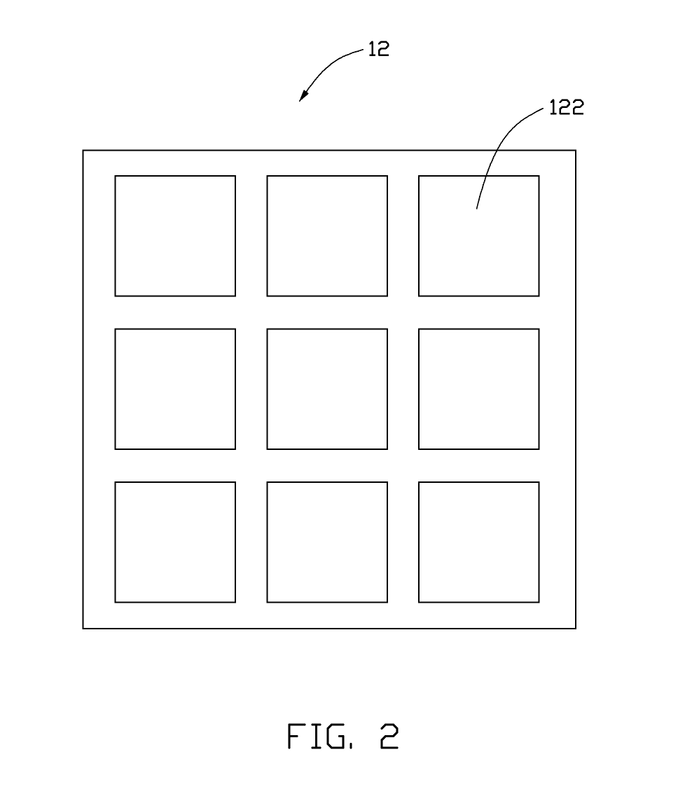

The laser 11 emits laser light to the DMD 12. The DMD 12 includes a number of micromirrors 122 arranged in an array. In one embodiment, the DMD 12 includes nine micromirrors 122 shown in FIG. 2.

The lens array 13 is mounted on a light emitting surface of the laser 11 by a fixing structure. The lens array 13 makes the laser light emitted by the laser 11 uniform. The lens array 13 includes a transparent substrate 132 and a number of truncated cones 134 formed on the transparent substrate 132. The transparent substrate 132 includes a first surface 1321 and a second surface 1322 parallel to the first surface 1321 and towards to DMD 12. The number of truncated cones 134 is mounted on the second surface 1322. A diameter of a top surface of each truncated cone 134 away from an end surface of the transparent substrate 132 is less than that of a bottom surface of each truncated cone 134 adjacent to the end surface of the transparent substrate 132. The diameter of each truncated cone 134 gradually increases from one end away from the transparent substrate 132 to another end adjacent to the transparent substrate 132. A center axis of each truncated cone 134 is vertical to the second surface 1322, and is parallel to the laser light emitted by the laser 11. In one embodiment, the lens array 13 only includes three truncated cones 134, for example. The diameter D1 of the top surface of each truncated cone 134 is more than 30 micron, and less than 50 micron. The diameter D2 of the bottom of each truncated cone 134 is more than 100 micron, and less than 200 micron. A height H of each truncated cone 134 is more than 20 micron, and less than 100 micron. In one embodiment, the D1 is equal to 40 micron, the D2 is equal to 120 micron, and the H is equal to 50 micron. The lens array 13 is made of optical material, such as polymethyl methacrylate (PMMA). The truncated cone 134 and the transparent substrate 132 are molded in one machine. In other embodiments, the truncated cone 134 and the transparent substrate 132 can be molded as two single machines, and the truncated cones 134 are affixed on the transparent substrate 132.

The projection lens 14 is arranged at a predetermined angle to the DMD 12. The laser light emitted by the laser 11 passing through the projection lens 14 is projected to a screen to form a projection image. Because the laser light emitted from the laser 11 is made uniform by the lens array 13, the problem of uneven Gaussian intensity distribution is solved, and brightness of the projection image is improved. In one embodiment, the projection lens 14 is a zoom lens. In other embodiment, the projection lens 14 is a prime lens.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A digital lighting process (DLP) projection device comprising:
a laser configured to emit laser light;
a digital micromirror device (DMD) arranged at a predetermined angle to the laser, and configured to receive the laser light emitted from the laser, wherein the DMD comprises a plurality of micromirrors arranged in an array, each of which is configured to reflect the laser light;
a projection lens arranged at a predetermined angle to the DMD, and configured to receive the laser light reflected from the micromirror, and project the received laser light; and
a lens array arranged between the laser and the DMD, configured to make the laser light emitted from the laser uniform.

2. The DLP projection device as described in claim 1, wherein the lens array comprises a transparent substrate, and a plurality of a truncated cones formed on the transparent substrate and towards to the DMD.

3. The DLP projection device as described in claim 2, wherein a center axis of each of the plurality of truncated cones is parallel to the laser light emitted from the laser.

4. The DLP projection device as described in claim 2, wherein a diameter of each of the plurality of truncated cones gradually increases from one end away from the transparent substrate to another end adjacent to the transparent substrate.

5. The DLP projection device as described in claim 1, wherein the laser is a laser diode.

6. The DLP projection device as described in claim 1, wherein the projection lens is a zoom lens.

7. The DLP projection device as described in claim 1, wherein the projection lens is a prime lens.

8. The DLP projection device as described in claim 2, wherein a diameter of a top surface of each of the plurality of truncated cones is more than 30 micron, and less than 50 micron.

9. The DLP projection device as described in claim 2, wherein a diameter of a bottom surface of each of the plurality of truncated cones is more than 100 micron, and less than 200 micron.

10. The DLP projection device as described in claim 2, wherein a height of each of the plurality truncated cones is more than 20 micron, and less than 100 micron.

11. The DLP projection device as described in claim 1, wherein the lens array is made of optical material.

12. The DLP projection device as described in claim 2, wherein the plurality of truncated cones and the transparent substrate are molded in one machine.

13. The DLP projection device as described in claim 2, wherein the plurality of truncated cones and the transparent substrate are molded as two single machines and the truncated cones are affixed on the transparent substrate.
